(19) United States
(12) Patent Application Publication
(10) Pub. No.: US 2020/0186463 A1
(43) Pub. Date: Jun. 11, 2020

(54) METHOD AND SYSTEM FOR NAME-BASED IN-NETWORKING PROCESSING

(71) Applicant: ELECTRONICS AND TELECOMMUNICATIONS RESEARCH INSTITUTE, Daejeon (KR)

(72) Inventors: Sae Hoon KANG, Daejeon (KR); Ji Soo SHIN, Daejeon (KR)

(21) Appl. No.: 16/705,473

(22) Filed: Dec. 6, 2019

(30) Foreign Application Priority Data
Dec. 7, 2018 (KR) 10-2018-0156602

(51) Int. Cl. H04L 12/717; H04L 12/775

(52) U.S. Cl. CPC H04L 45/42; H04L 45/58

(57) ABSTRACT

A method of determining an INP execution location for data processing in a name-based in-network system includes: receiving, by a first router, an INP interest packet; determining, by the first router, whether or not to perform an INP execution in the first router on the basis of user policy information and constraint information included in the INP interest packet. Herein, when the first router is capable of executing the INP, the first router generates an execution environment, and executes a function, and when the first router is not capable of executing the INP, the first router transfers the INP interest packet to a second router.

### CROSS REFERENCE TO RELATED APPLICATION

The present application claims priority to Korean Patent Application No. 10-2018-0156602, filed Dec. 7, 2018, the entire content of which is incorporated herein for all purposes by this reference.

### BACKGROUND OF THE INVENTION

### 1. Field of the Invention

The present invention provides a method and system for name-based in-network processing.

The present invention provides a method of providing, by a network infrastructure, desired data to a user and performing processing for the data in a name-based network environment.

In detail, the present invention provides a method of receiving a request for processing data of a name-based user in a name-based network, and performing computing processing at an appropriate location within the network and providing the result to the user.

### 2. Description of Related Art

Recently, the main application of the Internet has changed from traditional point-to-point communication to production and delivery of large-scale content. Internet users are interested in content that they want and are not interested in where the content are located. In response thereto, a concept of information centric networking (ICN) focused on named information (or content or data) departing from a conventional host-based communication mechanism. A method for name-based network processing may be required for the same. In ICN, all data is assigned with a name and communication is based on the name. As a representative ICN project, content centric networking (CCN) and named data networking (NDN) are provided. CCN and NDN are collectively referred to as NDN in the following because CCN and NDN are projects from the same root and there is no conceptual difference. In addition, terms of content, data, etc. are also collectively referred to as data used in the NDN.

### SUMMARY OF THE INVENTION

An objective of the present invention is to provide a method and system for name-based in-network processing.

Another objective of the present invention is to provide a method of determining an execution node for in-network processing in an ICN-based network.

Still another objective of the present invention is to provide a method of selecting the best execution node through a routing method based on content regardless of the help of a centralized server when determining an execution node.

Still another objective of the present invention is to provide a method of selecting the best execution node by reflecting a feature of a function and a user policy.

Still another objective of the present invention is to provide a method of selecting the best execution node for a new request.

Still another objective of the present invention is to provide a method of generating a new INP interest packet.

According to an embodiment of the present invention, there is provided a method of determining an in-network processing (INP) execution location for data processing in a name-based in-network system. Herein, the method may include: receiving, by a first router, an INP interest packet; and determining, by the first router, whether or not to perform an INP execution in the first router on the basis of user policy information and constraint information included in the INP interest packet. Herein, when the first router is capable of performing the INP execution, the first router may generate an execution environment, and execute a function, and when the first router is not capable of performing the INP execution, the first router may transfer the INP interest packet to a second router.

According to an embodiment of the present invention, there is provided a router for determining an in-network processing (INP) execution location for data processing in a name-based in-network system. Herein the router may include: a transmitting and receiving unit performing transmission and reception of information; and a processor controlling the transmitting and receiving unit. Herein, the processor may receive an INP interest packet through the transmitting and receiving unit, and determine whether or not to perform the INP execution in the router on the basis of user policy information and constraint information included in the INP interest packet. Herein, when the router is capable of performing the INP execution, the processor may generate an execution environment, and execute a function, and when the router is not capable of performing the INP execution, the processor may transfer the INP interest packet to another router.

According to an embodiment of the present invention, there is provided a system for determining an INP execution location for data processing in a name-based in-network system. Herein, the system may include a plurality of roosters, perform processing for data received from a user. When the system determines an INP execution location for data processing, a first router among the plurality of routers may receive an INP interest packet, and the first router may determine whether or not to perform an INP execution in the first router on the basis of user policy information and constraint information included in the INP interest packet. Herein, when the first router is capable of performing the INP execution, the first router may generate an execution environment, and execute a function, and when the first router is not capable of performing the INP execution, the first router may transfer the INP interest packet to a second router.

In addition, for data processing in a name-based in-network system, the below features may be commonly applied to the method, apparatus, and system for determining an INP execution location.

In addition, according to an embodiment of the present invention, the INP interest packet may include a routing name, a function name, and a function argument name.

In addition, according to an embodiment of the present invention, the routing name may indicate a routing direction of the INP interest packet, and the function name and the function argument name may be used when the function is executed after the execution environment is generated when the INP execution is performed.

In addition, according to an embodiment of the present invention, the user policy information may be set to at least one of a near-data location preference policy (NEAR DATA), a near-client location preference policy (NEAR_CLIENT), and an infrastructure delegating policy (ANY).

In addition, according to an embodiment of the present invention, when the user policy information corresponds to the near-client location preference policy, the INP execution location may be determined to a route that is closest to a user among routers satisfying the constraint information.

In addition, according to an embodiment of the present invention, when the user policy information corresponds to the near-data location preference policy, the INP execution location may be determined to a route that is closest to the data among routers satisfying the constraint information.

In addition, according to an embodiment of the present invention, when the user policy information corresponds to the near-data location preference policy, and the constraint information is satisfied, the first router may determine whether or not the first router is a final router when the INP interest packet is received.

In addition, according to an embodiment of the present invention, when the first router determines whether or not being the final router, the first router may transmit to the second router the received INP interest packet, a first packet generated by the first router, and a second packet generated by the first router.

Herein, according to an embodiment of the present invention, when the first router receives a response packet for the first packet from the second router, the first router may be determined to be the final router.

In addition, according to an embodiment of the present invention, when the first router receives a response packet for the second packet from the second router, whether or not the second router is the final router may be determined in the second router.

Herein, the first packet may be Int(R), and the second packet may be Int(R/F/A/CLS). In addition, according to an embodiment of the present invention, a method of generating an INP interest packet for an INP execution includes: generating an INP name field including a routing name, a function name, and a function argument name; and generating a parameter field including a user policy related to determining a location of an INP execution node.

In addition, according to an embodiment of the present invention, constraint information may indicate conditional information on the execution environment for executing the function.

In addition, according to an embodiment of the present invention, a second router may be a router subsequent to a first router.

According to the present invention, there is provided a method and system for name-based in-network processing.

According to the present invention, there is provided a method of determining an execution node for in-network processing in an ICN-based network.

According to the present invention, there is provided a method of selecting the best execution node through a routing method based on content regardless of the help of a centralized server when determining an execution node.

According to the present invention, there is provided a method of selecting the best execution node by reflecting a feature of a function and a user policy.

According to the present invention, there is provided a method of selecting the best execution node for a new request.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is a view showing NDN;

FIG. 2 is a view showing name-based in-network processing (INP);

FIG. 3 is a view showing a structure of an INP interest packet based on an NDN packet structure;

FIG. 4 is a view showing a structure of an INP router and an INP computing server;

FIG. 5 is a view showing an INP computing agent (ICA);

FIG. 6 is a view showing a method of determining an INP execution location in an IRA;

FIG. 7 is a view showing a method of determining an INP execution location; and

FIG. 8 is a view showing a configuration of each node according to the present invention.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

Hereinafter, the embodiments of the present disclosure will be described in detail with reference to accompanying drawings so that the embodiments may be easily implemented by those skilled in the art. However, the present invention may be realized in various forms, and it is not limited to the embodiments described herein.

Further, in the following description of the present disclosure, a detailed description of known functions and configurations incorporated herein will be omitted when it may make the subject matter of the present disclosure rather unclear. In addition, in the drawings, parts irrelevant to the description of the present disclosure are omitted, and like reference numerals designate like parts.

In the present disclosure, if a component were described as “connected”, “coupled”, or “inked” to another component, they may mean the components are not only directly “connected”, “coupled”, or “linked” but also are indirectly “connected”, “coupled”, or “linked” via one or more additional components. In addition, it will be understood that the terms “comprises”, “comprising”, or “includes” or “including” when used in this specification, specify the presence of one or more other components, but do not preclude the presence or addition of one or more other components unless defined to the contrary.

In the present disclosure, it will be understood that although the terms first and second are used herein to describe various elements, these elements should not be limited by these terms. Accordingly, within the scope of the present disclosure, a first component in one embodiment may be referred to as a second component in another embodiment, and likewise, a second component in one embodiment may be referred to as a first component in another embodiment.

In the present invention, the components that are distinguished from each other are intended to clearly describe the respective features, and do not necessarily mean that the components are separated. That is, a plurality of components may be integrated into one hardware or software unit, or one component may be distributed into a plurality of hardware or software units. Therefore, even if not mentioned otherwise, such integrated or distributed embodiments are included in the scope of the present disclosure.

In the present disclosure, components described in various embodiments are not necessarily required components, and some may be optional components. Therefore, an embodiment composed of a subset of components described in an embodiment is also included in the scope of the present disclosure. In addition, embodiments including other components in addition to the components described in the various embodiments are included in the scope of the present disclosure.

The advantages and features of the present invention and methods of achieving them will be apparent from the following exemplary embodiments that will be described in more detail with reference to the accompanying drawings. It should be noted, however, that the present invention is not limited to the following exemplary embodiments, and may be implemented in various forms. Accordingly, the exemplary embodiments are provided only to disclose the present invention and let those skilled in the art know the category of the present invention.

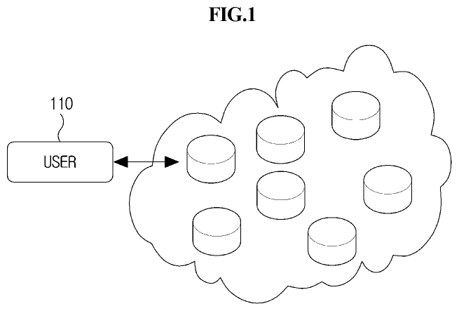

FIG. 1 is a view showing an operation method based on NDN. The above-described NDN may include at least one node connected to a user 110. Herein, each node may include a storage, or may be an entity where the storage is attached thereto. Herein, content required by the user 110 may be included in a node located close to the user 110 or obtained from the attached storage. In other words, in the NDN, content may be disposed in each node, and thus fast service to the user 110 may be available. In addition, in an example, the NDN may perform transmission and reception of content by using a name of the content rather than using an IP header. In detail, an interest configured with a name of content require by the user 110 may be broadcasted. Herein, the interest may be a content request packet of the user 110. In other words, the user 110 may transmit an interest to require content. Meanwhile, when a node storing the required content receives the interest, the corresponding node may transfer the content in response to the interest. Herein, in an example, the above-described NDN may be employed on the basis of a wired/wireless network, but it is not limited to the above example. In addition, in an example, a forwarding table in the NDN may be classified into a pending interest table (PIT) and a forwarding information base (FIB). Herein, the PIT may be information indicating the location of the user requiring the content. In addition, the FIB may indicate to where the interest is transferred. In the PIT, a name of an interest and an arrival point of the interest are mapped and stored.

In the NDN, two types of packets may be used. Herein, a packet type may be the above-described interest, and a data packet. In addition, in the NDN, communication may begin by a data consumer (or user). Herein, the consumer may transmit an interest packet by including a name of desired data to a network, and a router may perform routing based on a FIB (forwarding information base). When the router includes data matched with the name included in the interest packet, the corresponding data may be transmitted in the opposite direction by being included in a data packet.

In addition, when the router receives an interest packet that is forwarded to a subsequent node and a data packet associated thereto, the router may mange destination information through a PIT (pending information table). In addition, the router may perform caching for data transferred by the router in a content store (CS) for a preset time so as to process fast the same request afterwards.

In addition, in an example, in-network processing (INP) where a processing (or computing) function in a local host is delegated to a network may be considered. Through the above, necessary processing operations may be performed even though a sufficient resource is not present in a local host. In addition, processing may be performed in a node adjacent to data rather than receiving a necessary host in a local host, and thus fast processing can be available and network overhead can be reduced.

Herein, as an ICN-based INP, named function networking (NFN) and named function as a service (NFaaS) may be used. In an example, in the NFN, desired data is retrieved by extending a name resolution in the NDN to an expression resolution in a network, and the result thereof may be transferred by providing a calculation function.

In addition, the user may use lambda expression to name desired function processing, and transfer an execution result thereof to a network. Herein, the user may disclose to receive first a function name in lambda expression. In addition, the user may disclose to receive first an input data name in lambda expression. Through the above, a routing direction of an interest may be designated. Meanwhile, the network may continuously perform interest routing until content matched with the name that is disclosed first among data or function disclosed in the lambda expression is found. Herein, when the network gets a node that matches with the name, resolution for lambda expression may be performed in the corresponding node. In other words, the network may perform a processing process.

On the other hand, in the NFaaS, whether or not to install an execution code of a corresponding node may be determined according to popularity of a function in each node, and the popularity may be determined on the basis of a unikernel score based on a request frequency of the function and forwarding strategies. In the NFaaS, two types of forwarding strategies are defined which are based on a current delay time and a bandwidth. In an example, when using forwarding strategy based on a delay time, the above-described may be executed in an edge-side node. In addition, in an example, when using forwarding strategy based on a bandwidth, execution may be performed in a core-side node, but it is not limited to the above-described example.

In addition, as the NFN or NFaaS, in a conventional ICN-based in-network processing method, processing may be performed on the basis of a node including a matched function or data, or a node with at least a certain level of points for a required function. Herein, in case of a node including a matched function or data, an execution node is determined by whether or not the content is matched, and thus an execution location cannot be determined by reflecting a feature of the function or a policy of the user. Accordingly, routing has to be continuously performed until a router where corresponding content (function or data) is found in the cache, and thus the execution of the function becomes fail when a router where the cache is hit.

On the other hand, in case of a node with at least a certain level of points for a required function, an execution node is determined by a point based on popularity of the function, and thus a time to fill the point may be required. Accordingly, in case of a newly required function, there is a high probability that a location where the corresponding function is processed is not the best location.

In the following, an ICN technology is described based on NDN on the basis of the above description, but is not limited thereto.

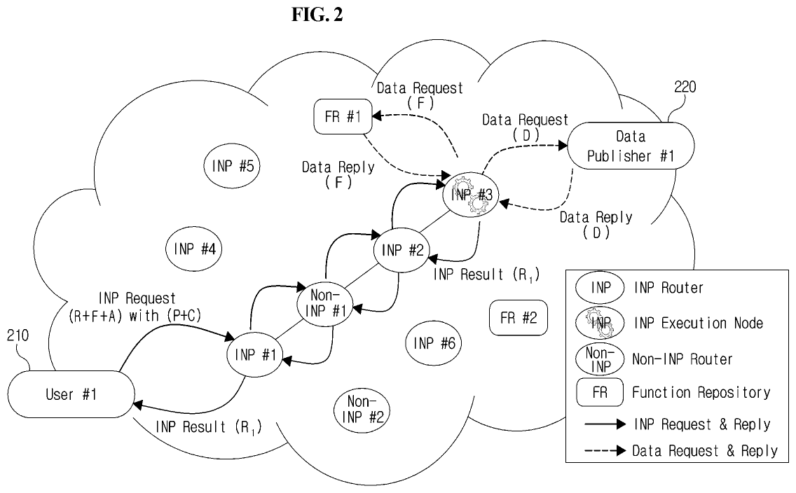

Herein, in an example, FIG. 2 is a view showing name-based in-network processing (INP).

Referring to FIG. 2, a network may be configured with an INP router providing INP processing and a Non-INP router that does not provide INP processing. Herein, the Non-INP router may only perform a function of forwarding an INP interest packet to a subsequent router on the basis of a name. Herein, packet processing identical to that of a general NDN interest packet is performed for an INP interest, which will be described later.

When the INP router receives an INP interest packet, the INP router may determine whether to perform an INP execution by itself or to transfer the INP interest packet to a subsequent node by referring to a user policy included in the interest and a constraint of an execution environment.

Herein, in an example, when it is determined that an INP execution in performed in the INP router, one of preset execution servers may be selected, and a request for generating an execution environment in the corresponding server may be transmitted. Herein, the corresponding server may generate an execution environment, and generate a running instance of the function by executing the required function. Herein, when data related to an execution code of the execution function is not present in a local environment of the server, the execution code may be downloaded by performing additional NDN data transferring. Subsequently, data processing for the running instance of the generated function may be performed by receiving data required for processing the function from a publisher of the data, and a result thereof may be transferred to the user. Herein, a process of transferring may be identical to the process of transferring in the NDN.

In an example, referring to FIG. 2, a user 210 (User #1) may make a request for content to INP. In other words, an INP interest packet may be transferred to the INP network by the user 210. Herein, in an example, an INP #1 may determine whether to process the INP interest received from the user 210 by itself or to transfer the interest to another INP. In an example, in FIG. 2, the INP #1 may transfer the INP interest to a NON-INP #1. Herein, the NON-INP #1 is a NON-INP, and thus may transfer again the INP interest to an INP #2. The INP #2 may also determine whether to process the INP interest by itself or to transfer the interest to another INP. In FIG. 2, the INP #2 may transfer the INP interest to an INP #3. Herein, the INP #3 may process the INP interest by itself, and for the same, make a request for generating an execution environment to a server. Accordingly, the execution environment may be set, and a running instance of the function may be generated by executing the required function. Subsequently, data processing may be performed for the running instance of the generated function by receiving data required for processing the function from a data publisher 220 (Data Publisher #1), and a result thereof may be transferred to the user 210. Herein, data transferred to the user may be transferred in an opposite direction of the INP interest packet.

In addition, the network may provide a function repository managing an execution code of a function used in INP processing. A function execution code provider may register an execution code in a function repository. In addition, an INP server executing INP processing may receive a function execution code from the function repository, and execute the function. When a function repository is not present in the network, an INP server has to directly receive data of an execution code from a publisher of a function execution code.

In FIG. 2, the user 210 (User #1) may transmit an INP interest to the network by combining a function F1 and data D1 into a name so as to obtain an INP result obtained by executing the function F1 using the data D1 as an input. Herein, a user polity P to be reflected in determining a location of an INP execution and a constraint C to be satisfied in the function execution environment may be included in the interest. The user policy P and the constraint C will be described later.

As described above, the INP interest may be transferred to the INP #3 by passing routers of INP #1, Non-INP #1, and INP #2, and the INP #3 may determine to execute required INP, generate an execution environment, and generate a running instance by downloading an execution code of the function F1. Herein, data processing may be performed for the generated running instance by receiving input data D1 from the data publisher 220 (Data Publisher #1), and a result thereof may returned to the user 210 via a path in the opposite direction where the INP interest has been transferred, as described above.

Meanwhile, in the INP interest, a name may be configured with an expression of Table 1 below. In an example, an INP name may constitute an integrated name where a routing name, a function name, a function argument name are combined. Herein, each name may be defined in a form of a TLV (type-length-value), and an independent type may be defined for each name. In an example, in the NDN, 7 may be defined as a number of a general name type, and values of 128 to 252 are used for application purposes. The independent type may be defined by using the above values. In an examples below, it may be defined that 7 is used for a type of a routing name (routing_name), 222 is used for a function name (function_name), and 223 is used for a function argument name (argument_name), but the above is just one example, and is not limited thereto. In addition, in addition to the above, an additional type number may be designated and used for an interest and a data name generated for INP purposes.

Meanwhile, a routing name may be used for determining a routing direction of an INP interest packet by being longest-prefix matched in the above-described FIB. Accordingly, the user may designate the routing direction of the INP interest packet. In an example, when a data name is used for a routing name, an INP interest may be routed toward a location where corresponding data is published. On the other hand, when a function name is designated in a routing name, an INP interest packet may be routed toward a location where the corresponding function is published. In another example, when a server name is directly designated in a routing name, an INP interest packet may be routed to an INP processing node.

In addition, in an example, a function name and an argument name may be use for purposes of INP processing in an INP router. The argument name may include a plurality of input values to be used as input for a function execution, and also include a name of data to be processed, a set value for the function execution.

In an INP interest, each name may be set, and the name may be the same as Equation 1 below.

TABLE 1

- INP interest naming expression -

[routing_name]/[function_name]/[arguments_name]/%FD[version]/%00
[segment_number]

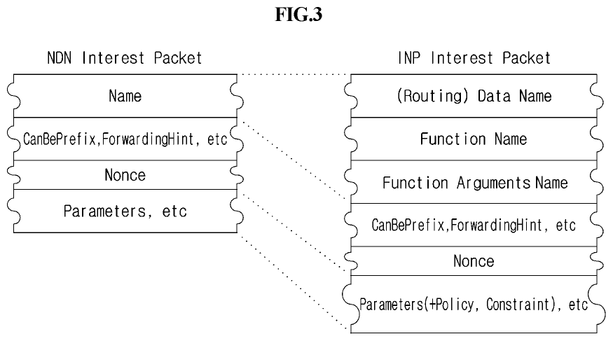

In addition, in an example, FIG. 3 is a view showing a structure of an INP interest packet on the basis of an NDN packet. Referring to FIG. 3, in an INP interest packet, as described above, a name may be configured with a routing name, a function name, and an argument name. In other words, in an NDN packet structure, a field structure corresponding to a name may be configured with, as described above, a plurality of names. Meanwhile, in an example, a user polity and a constraint for a function execution may be further included as a parameter. Herein, in an example, each of the above-described field may be defined in an additional TLV form as the name.

Herein, in an example, a user policy may be an essential field for reflecting user requirements when determining an INP execution location. In detail, the user may desire that the INP execution location becomes close to data so as to reduce traffic. In addition, in an example, the user may desire that INP is executed close to him or her so as to reduce a response time. In addition, in an example, in addition to the above-described user policy, another policy may be set, and it is not limited to the above-described example. In an example, a near-data location preference policy (NEAR_DATA) may be used. In another example, a near-client location preference policy (NEAR_CLIENT) may be used. In another example, a policy (ANY) that entirely delegating to an infrastructure may be used, or another policy may be defined and used. In addition, a constraint may mean at least condition that an execution environment has to satisfy for a function execution. In an example, the constraint may be the minimum number of assigned cores, or a GPU provided for accelerated processing, etc. Related to the constraint, each constraint may be defined in a TLV form, and the additional type number may be assigned. In addition, the INP router may determine first whether or not an execution environment capable of satisfying a constraint under a local computing environment is possibly generated when determining an INP processing location, and the above field may be a field for the same.

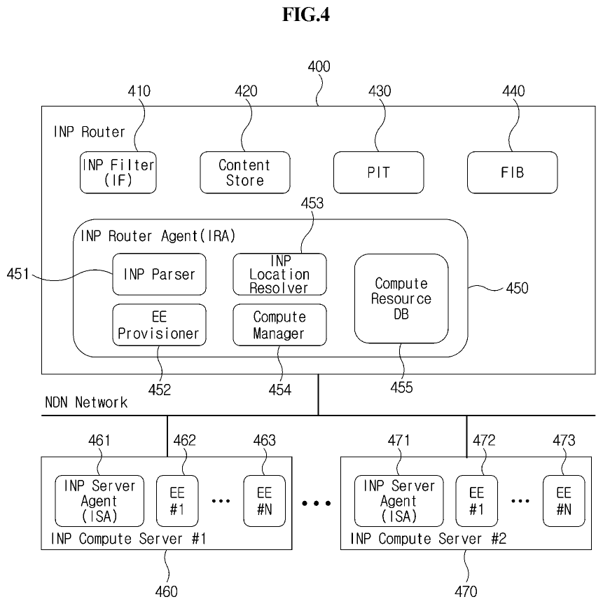

FIG. 4 is a view showing a structure of an INP router and an INP computing server (compute server). Referring to FIG. 4, an INP router 400 may operate in conjunction with one or more computing servers 460 and 470. Herein, in an example, the INP router 400 and the INP computing server (or servers 460 and 470) may be connected through an NDN network. In other words, NDN-based communication may be provided. Herein, the INP computing servers 460 and 470 may be configured with INP server agents (ISA) 461 and 471 providing operation in conjunction with the INP router 400, and execution environments (execution engine) 462, 463, 472, and 473. Herein, the ISAs 461 and 471 may perform functions of generating and managing the execution environment. In addition, the ISAs 461 and 471 may perform functions of execution management, etc., and additionally periodically transmit a state of a local resource to the IRA (INP router agent) 450.

Meanwhile, the INP router 400 may include a CS 420, a PIT 430, and a FIB 440 which are provided in a conventional NDN router. In addition, the INP router 400 may further include an INP filter 410, and an IRA 450, but it is not limited to the above-described example.

Herein, in an example, the CS 420, the PIT 430, and the FIB 440 may perform functions identical to those in the NDN router, as described above. In other words, the CS 420 may be for temporarily storing data passing the router. Herein, when the NDN router receives an interest, the CS 420 may check whether or not data matching with the interest is present, if so, transmit data to an interface from which the interest is received so as to prevent the interest packet from being transferred further. In addition, the PIT 430 is for storing information on a reception interface and a transmission interface of the interest that is transferred to a subsequent node. When an interest having a name identical to a name of an interest that has been already transferred is received, transferring may not be performed further, and information on an interface in which the corresponding interest is received may be added, as described above. In addition, the FIB 440 may include forwarding information on a name prefix, and manage through routing protocol.

In addition, as an additional configuration, the INP filter 410 may perform filtering so as to only transfer an INP packet among an interest and a data packet received in the router to the IRA 450. Herein, the INF filter 410 may identify a type number included in a name of the received packet, and determine whether or not to the type corresponds to an INP type so as to determine whether or not being an INP packet.

In addition, the IRA 450 may further include at least one of an INP parser 451, an EE provisioner, 452, an INP location resolver 453, a computing manager 454, and a computing resource DB (CRDB) 455.

Herein, the computing manager (CM) 454 may manage set information on a computing server possibly used for INP purposes in a local environment. In addition, the CM 454 may periodically monitor resource information on the computing server, and store the result in the CRDB.

In addition, FIG. 5 is a view showing an INP computing agent (ICA).

Referring to FIG. 5, an ICA 510 may include at least one of a resource manager 511, an EE manager 512, and a local function code manager 513. Herein, connection of the ICA 510 may be also employed on the basis of the NDN. Herein, the ICA 510 may manage a resource, an execution environment, and a function code through respective configurations, but it is not limited to the above-described example. The resource manager 511 may manage a resource of a local server, and transfer a local resource situation according to a request of the computing manager 454 of the corresponding IRA. The EE manager 512 may perform functions of generating, removing, set management, etc. of a new execution environment (EE) according to a request of the EE provisioner 452, and of downloading an execution code of a required function when the execution environment is generated so as to perform the execution code. The local function code manager 513 may perform functions of managing an execution code of a function required in a local execution environment, and downloading and storing an execution code in advance from a function repository function so as to rapidly perform execution, or function as a temporary storage for an execution code that is downloaded in a local execution environment and in operation for reuse afterward.

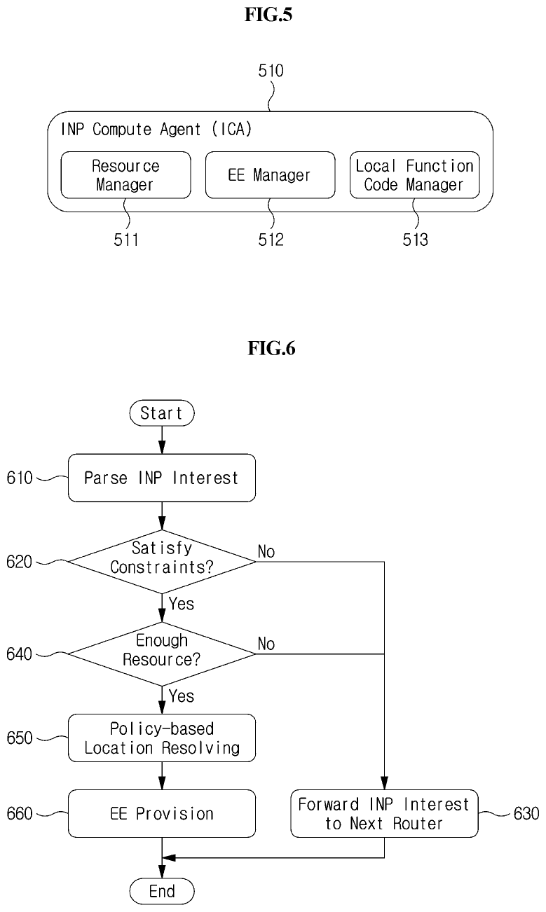

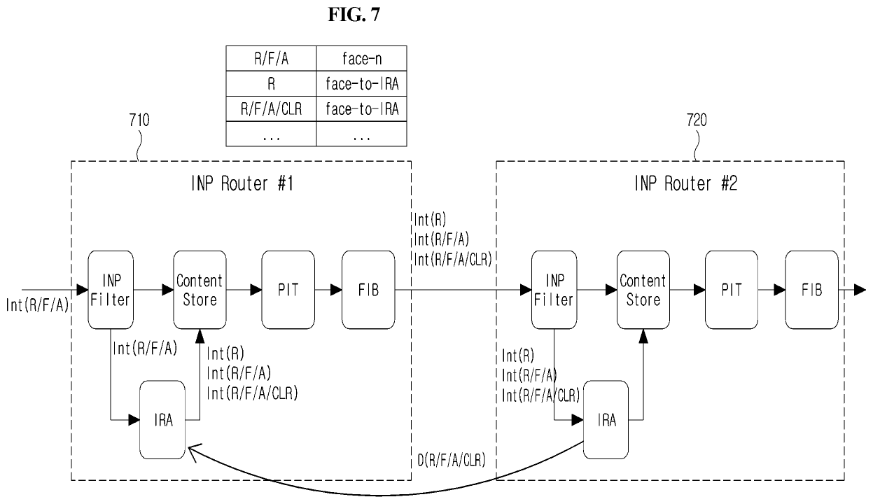

FIG. 6 is a view showing a method of determining an INP execution location in an IRA. Referring to FIG. 6, in S610, when the router receives an INP interest packet, the INP parser may identify a routing name, a function name, and an argument name from a name included in the INP interest packet. In addition, the INP parser may identify information on a user policy and a constraint included in a parameter field.

Subsequently, in S620, the INP location resolver (ILR) may determine an INP execution location. Herein, the INP location resolver may determine whether or not a computing server satisfying a constraint defined in the INP interest is present in a local environment by referring to the computing resource database. Herein, when the computing server is not present in the local environment, that is, when the constraint is not satisfied, in S630, the router may forward the INP interest packet to a subsequent router. On the other hand, when the computing server is present in the local environment, that is, when the constraint is satisfied, in S640, the ILR may determine a computing server to which resource assignment for INP execution is available. Herein, whether or not resource assignment for the computing server is available may be determined by using algorithms different from each other according to the independent server, and the above information may be collected by the CM and stored in the CRDB. In an example, in S630, when a server capable of assigning the resource is not present, that is, when the resource is not sufficient, the router may forward the INP interest packet to a subsequent router.

In addition, when a server capable of assigning the resource is present, that is, when the resource is sufficient, in S650, the ILR may determine whether or not executing the INP in the local server is appropriate by using the user policy included in the INP interest. In an example, when the user policy is “CLIENT_NEAR”, the corresponding node satisfies the constraint and assigning the required resource is also available, and thus an execution environment may be generated in the computing server through the EE provisioner, and a function may be executed therein. In another example, when the user policy is “ANY”, whether or not to perform execution may be determined according to a local policy of the INP router.

In addition, in an example, in the above, a local policy may be preset by the manager. In an example, when an available resource is sufficient, an execution environment is unconditionally generated, and when the available resources becomes equal to or smaller that a certain level, the probability of transferring to a subsequent node may be increased.

Herein, when the user policy is “CLIENT_NEAR” or “ANY”, since the determining of the execution location has already been completed, in S660, generating the execution environment and executing the function may be started without a triggering event.

In another example, when the user policy is “NEAR_DATA”, the user may desire that the INP is performed close to a location of data. However, the INP router cannot determine that the INP router itself is the best INP execution location as the location of the corresponding data is not provided. In other words, a process of determining an INP execution location in a cascading manner may be performed. In the method, the node may determine whether or not a subsequent node on a routing path is a location more appropriate than the node itself may be determined. Subsequently, when a node closer to the data is determined, the corresponding node may determine whether or not a subsequent node is closer to the data for performing INP execution may be repeatedly performed.

For determining an execution location where a “NEAR_DATA” policy is applied, first, in preparation for the possibility that the node itself becomes the node closest to the data for execution, preparation for generating the execution environment may be registered in the EE provisioner. The above may mean a temporary reservation for a local resource. Herein, a triggering event for generating an execution environment, and a command line for executing a function after generating the execution environment may be registered together. The EE provisioner may only prepare for generation of an execution environment, and practical generation of the execution environment may be performed when a triggering event is received.

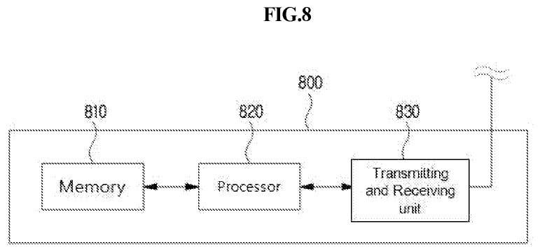

FIG. 7 is a view showing a method of determining an INP execution location.

Referring to FIG. 7, the INP Router #1 710 (IR #1) may receive an INP interest packet Int(R/F/A) having a name of R/F/A configured with a routing name (routing_name, R), a function name (function_name, F), and an argument name (argument_name, A). Herein, the ILR may determine an INP execution location. However, FIG. 7 is a view showing one example for convenience of description, and it is not limited thereto. The ILR of the IR #1 710 may determine first whether or not the INP execution is available in a local node on the basis of a constraint and an available resource. Herein, when INP execution is not available, Int(R/F/A) may be transferred to a subsequent node and the process may be finished, as described with reference to FIG. 6.

On the other hand, when INP execution is available in a local node, the ILR may determine first whether or not a current node is a final node. Herein, in order to determine whether or not the current node is the final node, the ILR may determine whether or not data is stored in the cache of the local content store (CS) by performing matching with the same routing name. In other words, as described above, content may be stored in the cache of the CS, and when data matching with the routing name is present in the CS, routing may not be proceeded further, and the corresponding INP router is determined as the final execution node. Herein, when the routing name is matched, the ILR may immediately generate an execution environment through the EE provisioner, perform INP execution, and finish the process. Subsequently, the ILR may register preparation for generating an execution environment in the EE provisioner, and when D(R) is received, register a triggering event so as to start the generating of the execution environment.

However, as described above, the ILR may additionally generate an interest packet to transfer to a subsequent node so that the subsequent node on a routing path determines whether or not being an appropriate node. Herein, the node may transmit the received Int(R/F/A) packet to the subsequent node, and at the same time forward to the subsequent node by generating an Int(R)packet and an Int(R/F/A/CLR). Herein, for a name R used in the Int(R), an additional TLV type number may be used for the same so as to be distinguished from a name type of the NDN. Accordingly, the same may be distinguished from the interest packet in the above-described NDN. Herein, an incoming face of the Int(R) and the Int(R/F/A/CLS) which is registered in a PIT table may be set as a face of face-IRA that is connected to a local IRA, and transferred to the IRA when a data packet associated therewith is received later. Subsequently, the INP Router #2 720 (IR #2) may receive three types of interest packets which are Int(R/F/A), Int(R), and Int(R/F/A/CLS), etc. Herein, all of the above packets may be transferred to the IRA after performing filtering therefor. Herein, the ILR of the IR #2 720 may determine whether or not INP execution is available in a local node on the basis of a constraint and an available resource as described above. Herein, when INP execution is not available, the ILR may bypass the Int(R/F/A) to a subsequent node, and finish the process. On the other hand, when NP execution is available in the IR #2 720, the ILR may transmit a data packet D(R/F/A/CLS) in response to the Int(R/F/A/CLS) so as to finish the determining of the INP execution location in the IR #2 720. Accordingly, when the IR #1 710 receives D(R/F/A/CLS), the IR #1 710 may transfer the above-described packet to the IRA by the PIT. Herein, the IR #2 720 may finish the determining of the INP execution location, and the IRA may remove the existing preparation entry for generating the execution environment which is registered in the EE provisioner, and finish the determining of the INP execution location.

Meanwhile, the IR #2 720 may forward the received Int(R/F/A) packet as it is to a subsequent node so as to determine whether or not the subsequent node is more appropriate node than itself, and at the same time generate Int(R) and Int(R/F/A/CLR) to forward to the subsequent node. Herein, as described above, for a name R used in Int(R), an additional TLV type number is used so as to be distinguished from a name type of the NDN, and thus Int(R) may be easily distinguished from an interest packet in a general NDN, as described above. In other words, the INP execution location may be determined by a cascading method.

On the other hand, when the IR #1 710 receives a data packet D(R), the packet may be also transferred to the IRA through the PIT, and generating an execution environment and executing a function may be started by being matched with a triggering event registered in the EE provisioner. In other words, when the data packet D(R) is transmitted from the IR #2 720 to the IR #1 710, the IR #1 710 may start the generating of the execution environment and the executing of the function on the basis of the registered triggering event.

Herein, when a triggering event for generating an INP execution environment for a specific INP interest occurs by the EE provisioner, the EE provisioner may select a computing server that is reserved in advance, and make a request for generating the execution environment and executing the function to the ISA of the corresponding server. Subsequently, the execution environment may be generated, and the function may be executed. Herein, a learning instance of the function may receive necessary data, perform calculation, and transfer the result to the user.

Through the above, in INP processing where data processing is delegated to the network, the best execution location may be determined within the network by reflecting a user policy regardless of the help of a centralized server. Accordingly, a user customized INP execution location can be determined, and network efficiency can be improved. In addition, an execution node capable of providing requirements of an independent function can be selected, and thus the best execution environment for the independent function can be provided, but it is not limited to the above-described example.

In addition, as mentioned above, an INP execution may mean that data that is transferred from a data publisher is processed in the corresponding router (or node), and the processed data is transferred to the user. Herein, when an INP execution is performed, the corresponding router make a request for generating an execution environment to a connected server, and the corresponding server may generate the execution environment and execute a required function so as to generate a running instance of the function. Subsequently, the corresponding router may receive data required for processing the data from the data publisher in the generated running instance of the function so as to process the data, and transfer the result to the user. In other words, the INP execution may be a method of determining a router (or node) determining the above operations.

FIG. 8 is a view showing a configuration of each node according to the present invention.

As described above, in an in-network system, a plurality of nodes (or routers) may be present. Herein, in the in-network system, in order to process data received from the user, an INP execution location may be determined. In other words, a node for an INP execution in the in-network may be determined.

Herein, in an example, a configuration of an apparatus of FIG. 8 may be a configuration of a node (or router) in the in-network system.

In an example, each node 800 may further include, as shown in FIG. 8, at least one of a memory 810, a processor 820, and a transmitting and receiving unit 830. Herein, in an example, the memory 810 may be for storing the above described user policy information or constraint information. In addition, the memory 810 may be for storing other information, but is not limited to the above-described example. In addition, the transmitting and receiving unit 830 may transmit an INP interest packet or data for which INP is executed to another node. In other words, the transmitting and receiving unit 830 may be a configuration for transmitting and receiving data or information to/from other devices, but is not limited to the above-described example.

In addition, the processor 820 may control the information included in the memory 810 on the basis of the above. In addition, the processor 820 may transmit information related to an in-network system to another node or apparatus through the transmitting and receiving unit 830, but is not limited to the above-described example.

In order to realize the method according to the present invention, other steps may be added to the illustrative steps, some steps may be excluded from the illustrative steps, or some steps may be excluded while additional steps may be included

The various embodiments of the present invention are not intended to list all possible combinations, but to illustrate representative aspects of the present invention. The matters described in the various embodiments may be applied independently or in a combination of two or more.

Further, the various embodiments of the present invention may be implemented by hardware, firmware, software, or combinations thereof. In the case of implementation by hardware, implementation is possible by one or more application specific integrated circuits (ASICs), digital signal processors (DSPs), digital signal processing devices (DSPDs), programmable logic devices (PLDs), field programmable gate arrays (FPGAs), general processors, controllers, micro controllers, microprocessors, or the like.

The scope of the present invention includes software or machine-executable instructions (for example, an operating system, an application, firmware, a program, or the like) that cause operation according to the methods of the various embodiments to be performed on a device or a computer, and includes a non-transitory computer-readable medium storing such software or instructions to execute on a device or a computer.

What is claimed is:

1. A method of determining an in-network processing (INP) execution location for data processing in a name-based in-network system, the method comprising:
receiving, by a first router, an INP interest packet; and
determining, by the first router, whether or not to perform an INP execution in the first router on the basis of user policy information included in the INP interest packet,
wherein when the first router is capable of performing the INP execution, the first router generates an execution environment, and executes a function, and
when the first router is not capable of performing the INP execution, the first router transfers the INP interest packet to a second router.

2. The method of claim 1, wherein the INP interest packet includes a routing name, a function name, and a function argument name.

3. The method of claim 2, wherein the routing name indicates a routing direction of the INP interest packet, and the function name and the function argument name are used when the function is executed after the execution environment is generated when the INP execution is performed.

4. The method of claim 1, wherein the user policy information is set to at least one of a near-data location preference policy (NEAR DATA), a near-client location preference policy (NEAR_CLIENT), and an infrastructure delegating policy (ANY).

5. The method of claim 4, wherein the INP interest packet includes constraint information, and
wherein when the user policy information corresponds to the near-client location preference policy, the INP execution location is determined to a route that is closest to a user among routers satisfying the constraint information.

6. The method of claim 4, wherein the INP interest packet includes constraint information, and
wherein when the user policy information corresponds to the near-data location preference policy, the INP execution location is determined to a route that is closest to the data among routers satisfying the constraint information.

7. The method of claim 6, wherein when the user policy information corresponds to the near-data location preference policy, and the constraint information is satisfied, the first router determines whether or not the first router is a final router when the INP interest packet is received.

8. The method of claim 7, wherein when the first router determines whether or not being the final router, the first router transmits to the second router the received INP interest packet, a first packet generated by the first router, and a second packet generated by the first router.

9. The method of claim 8, wherein when the first router receives a response packet for the first packet from the second router, the first router is determined to be the final router.

10. The method of claim 8, when the first router receives a response packet for the second packet from the second router, whether or not the second router is the final router is determined in the second router.

11. The method of claim 8, wherein the first packet is Int(R), and the second packet is Int(R/F/A/CLS).

12. The method of claim 1, wherein in the determining of whether or not to perform the INP execution, constraint information is additionally used, wherein the constraint information indicates conditional information on the execution environment for performing the function.

13. The method of claim 1, wherein the second router is a router subsequent to the first router.

14. A router for determining an in-network processing (INP) execution location for data processing in a name-based in-network system, the router comprising:
a transmitting and receiving unit performing transmission and reception of information; and
a processor controlling the transmitting and receiving unit,
wherein the processor receives an INP interest packet through the transmitting and receiving unit, and determines whether or not to perform the INP execution in the router on the basis of user policy information included in the INP interest packet,
wherein when the router is capable of performing the INP execution, the processor generates an execution environment, and executes a function, and
when the router is not capable of performing the INP execution, the processor transfers the INP interest packet to another router.

15. The router of claim 14, wherein the INP interest packet includes a routing name, a function name, and a function argument name.

16. The router of claim 15, wherein the routing name indicates a routing direction of the INP interest packet, and the function name and the function argument name are used when the function is executed after the execution environment is generated when the INP execution is performed.

17. The router of claim 14, wherein the user policy information is set to at least one of a near-data location preference policy (NEAR DATA), a near-client location preference policy (NEAR_CLIENT), and an infrastructure delegating policy (ANY).

18. The router of claim 14, wherein the INP interest packet includes constraint information, and
wherein the constraint information indicates conditional information on the execution environment for executing the function.

19. The router of claim 14, wherein the other router to which the processor transfers the INP interest packet is a subsequent router connected to the router.

20. A method of generating an in-network processing (INP) interest packet for an INP execution, the method comprising:
generating an INP name field including a routing name, a function name, and a function argument name; and
generating a parameter field including a user policy related to determining a location of an INP execution node.
